(19) United States
(12) Patent Application Publication
(10) Pub. No.: US 2026/0163634 A1
(43) Pub. Date: Jun. 11, 2026

(54) UNIFIED TCI FRAMEWORK EXTENSION FOR mTRP-BASED OPERATION IN WIRELESS COMMUNICATION

(71) Applicant: APPLE INC., Cupertino, CA (US)

(72) Inventors: Hong HE, San Jose, CA (US); Chunhai YAO, Beijing (CN); Chunxuan YE, San Diego, CA (US); Dawei ZHANG, Saratoga, CA (US); Haitong SUN, Cupertino, CA (US); Seyed Ali Akbar FAKOORIAN, San Diego, CA (US); Wei ZENG, Saratoga, CA (US)

(21) Appl. No.: 18/709,366

(22) PCT Filed: May 11, 2023
(86) PCT No.: PCT/CN2023/093496

§ 371 Date: May 10, 2024

(51) Int. Cl. H04B 7/06; H04L 5/00; H04W 72/231; H04W 76/20; H04W 80/02

(52) U.S. Cl. CPC H04B 7/06968; H04L 5/001; H04W 72/231; H04W 76/20; H04W 80/02

(57) ABSTRACT

Processes and systems for a unified transmission configuration indication (TCI) framework extension for multi-transmission and reception point (TRP) operation in wireless communication networks. For a unified TCI-state extension from sTRP to mTRP the system is configured to support switching between a single TRP (sTRP) mode operation and an mTRP mode operation. For a unified TCI-state extension from sTRP to mTRP the system is configured to support up to 4 TCI-states for association with a single TCI codepoint

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

Fifth generation (5G) wireless networks support increased connectivity, high capacity, ultra-reliability and low latency, relative to legacy networks. Multiple transmission and reception points (multi-TRPs) can improve reliability, coverage, and capacity performance through flexible deployment scenarios. For example, to be able to support the exponential growth in mobile data traffic in 5G and to enhance the coverage, the wireless devices access networks composed of mTRPs (e.g., macro-cells, small cells, pico-cells, femto-cells, remote radio heads, relay nodes, etc.).

This document describes processes and systems for a unified transmission configuration indication (TCI) framework extension for multi-transmission and reception point (TRP) operation in wireless communication networks. mTRP enables 5G next-generation nodes (gNB) or other base stations to use more than one transmission and reception point (TRP) to communicate with user equipment (UE).

The TCI framework is extended to mTRP use cases based on an extension of the unified TCI framework for indicating multiple DL and uplink (UL) TCI states. Specifically, the processes are extended to multi-TRP use cases. For a unified TCI-state extension from sTRP to mTRP the system is configured to support switching between a single TRP (sTRP) mode operation and an mTRP mode operation.

For a unified TCI-state extension from sTRP to mTRP the system is configured to support up to 4 TCI-states for association with a single TCI codepoint, rather than 2 TCI-states. Specifically, for a TCI codepoint associated with fewer than four TCI-states, the system is configured to indicate or determine that each activated joint/DL/UL TCI state corresponds to the first or second joint/DL/UL TCI state within a full set TCI-states. In addition, this document describes how to efficiently support a component carrier (CC) group-based TCI-state indication for CCs with mixed sTRP and mTRP modes.

In accordance with one aspect of the present disclosure, an example process includes receiving, at a user equipment (UE), configuration data from a wireless communication network, the configuration data including a transmission configuration indicator (TCI) field that describes one or more TCI states for at least one cell of the communication network. The process includes selecting, by the UE, in accordance with the configuration data, a transmission and reception point (TRP) mode of the UE, the TRP mode being a single TRP (sTRP) mode or a multi-TRP (mTRP) mode. The process includes transmitting, by the UE to a cell of the wireless communications network, data based on the selected TRP mode, the cell of the wireless communication network also operating in the TRP mode.

In some implementations, the configuration data specifies a first number of TCI states for uplink transmissions and a second number of TCI states for downlink transmissions. In some implementations, the UE is configured to select the sTRP mode when the first number of TCI states and the second number of TCI states that are indicated in the configuration data are each an integer value that is less than two. In some implementations, the UE is configured to select the mTRP mode when the first number of TCI states or the second number of TCI states that are indicated in the configuration data include an integer value that is greater than one. In some implementations, a TCI mode is explicitly specified in a TCI field of a downlink control information (DCI) format. In some implementations, the configuration data include a logical cell identifier (eLCID), and wherein the TRP mode is based on a value of the eLCID. In some implementations, the configuration data are included in a medium access control (MAC) control element (CE), the MAC CE including a plurality of fields, wherein the plurality of fields specify a set of TCI states associated with a TCI codepoint. In some implementations, a first field value of a field of the plurality indicates a first pair of the TCI states of the full TCI state set, and wherein a second field value of the field of the plurality indicates a second pair of the TCI states of the set of TCI states. In some implementations, a MAC subheader of the MAC CE specifies an eLCID that indicates a cell associated with the set of TCI states. In some implementations, the UE is configured to update the TCI states for a cell associated with the TCI codepoint indicated in the MAC CE, and wherein the UE maintains other TCI states that are not updated in the MAC CE for the cell associated with the TCI codepoint. In some implementations, the configuration data is a part of radio resource control (RRC) signaling, and wherein the TCI field indicates TCI states for a TCI codepoint for updating by the UE. In some implementations, the RRC signaling includes a downlink/uplink identifier field and a pair identification field.

In accordance with one aspect of the present disclosure, an example process includes receiving, at a user equipment (UE), configuration data including a component carrier (CC) list for a cell group, the CC list specifying a reference cell and a transmission configuration indicator (TCI) specifying one or more TCI states for the reference cell, wherein the other cells in the CC list are configured to use the one or more TCI states specified for the reference cell. The process includes selecting, by the UE, in accordance with the configuration data, a transmission and reception point (TRP) mode of the UE, the TRP mode being a single TRP (sTRP) mode or a multi-TRP (mTRP) mode. The process includes transmitting, by the UE to a cell of the wireless communications network, data based on the selected TRP mode, the cell of the wireless communication network also operating in the TRP mode.

In some implementations, the CC list includes one or more sTRP CCs and one or more sDCI-based mTRP CCs. In some implementations, the reference cell is configured with a sDCI-based mTRP CC, and wherein radio resource control (RRC) signaling specifies that a first group, a second group, or both groups of TCI-states for the reference cell are used for sTRP.

In some implementations, the CC list includes one or more sTRP CCs and one or more mDCI-based mTRP CCs. In some implementations, the reference cell is configured with an sDCI-based mTRP CC, and wherein radio resource control (RRC) signaling specifies a value for a CORESET pool index. In some implementations, the CC list includes one or more sDCI-based mTRP CCs and one or more mDCI-based mTRP CCs. In some implementations, one of CCs with sDCI-based mTRP is indicated as reference CC. In some implementations, one of CCs with mDCI-based mTRP is indicated as reference CC. In some implementations, a first TCI state of sDCI-based mTRP is mapped to the indicated TCI-state specific to a first CORSET pool index value.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example of a network configured to switch between a single TRP mode (sTRP) and a multi-TRP (mTRP) mode.

FIG. 3 shows an example of a full set of TCI-state combinations for a joint TCI state mode and a separate TCI-state mode.

FIG. 4 illustrates an example of a medium access control (MAC) control element (CE) for updating a TCI state.

FIGS. 5A-5B show an example of a radio resource control (RRC)-based TCI-state update indication for single downlink control information (sDCI)-based multi-TRP.

FIG. 6 illustrates an example of a cell-group based TCI-state in which a CC list includes both sTRP-based mTRP operation and sDCI-based mTRP operation.

FIG. 7 illustrates a flowchart of an example method, according to some implementations.

FIG. 8 illustrates a flowchart of an example method, according to some implementations.

FIG. 9 illustrates an example user equipment (UE), according to some implementations.

FIG. 10 illustrates an example access node, according to some implementations.

### DETAILED DESCRIPTION

This document describes processes and systems for a unified transmission configuration indication (TCI) framework extension for multi-transmission and reception point (TRP) operation in wireless communication networks. mTRP enables 5G next-generation nodes (gNB) or other base stations to use more than one transmission and reception point (TRP) to communicate with user equipment (UE). Beam management in 5G downlink (DL) includes the (TCI) signaling framework in which a beam for a target or channel/signal (e.g., PDSCH, PDCCH, CSI-RS) that is to be received by the UE is indicated by a TCI state. TCI states are dynamically sent over in a downlink control information (DCI) message. The DCI message includes configurations such as quasi-co-location (QCL) relationships between the downlink (DL) reference signals (RSs) in one control state information reference signal (CSI-RS) set and the physical downlink shared channel (PDSCH) demodulation reference signal (DMRS) ports. A unified TCI framework enables a streamlined multi-beam operation for frequency range 2 (FR2). More specifically, each link direction (UL, DL) follow a single TCI-state, such as an analog beam for all channels, streamlining beam management. This document describes an extension from single-TRP (sTRP) use cases to a unified TCI framework that focuses on multi-TRP (mTRP) use cases.

The TCI framework is extended to mTRP use cases based on an extension of the unified TCI framework for indicating multiple DL and uplink (UL) TCI states. Specifically, the processes are extended to multi-TRP use cases. For a unified TCI-state extension from sTRP to mTRP the system is configured to support switching between a single TRP (sTRP) mode operation and an mTRP mode operation. The difference between these modes is the number of TCI state that are supported (e.g., multiple states rather than one). For example, each TRP of the mTRP (e.g., 2 TRPs) can be associated with multiple TCI states. An explicit indication can be provided from the network to the UE to configured mTRP to avoid a mismatch between the network and the UE, such as a misalignment between the transmission and reception beams of the UE and network, respectively.

For a unified TCI-state extension from sTRP to mTRP the system is configured to support up to 4 TCI-states for association with a single TCI codepoint, rather than 2 TCI-states. Specifically, for a TCI codepoint associated with fewer than four TCI-states (e.g., N=2 with {DL TCI-state=3, UL TCI-state=2}), the system is configured to indicate or determine that each activated joint/DL/UL TCI state corresponds to the first or second joint/DL/UL TCI state within a full set TCI-states. For increased flexibility, fewer than all four TCI states may need to be updated when the UE is moving. For example, only 3 TCI states (or fewer) may be updated. The UE can indicate to the network how the UE has updated the TCI states.

This document describes how to efficiently support a component carrier (CC) group-based TCI-state indication for CCs with mixed sTRP and mTRP modes. In legacy systems, a reference cell TCI state is updated, and each cell of the cell group has a corresponding updated TCI state. The processes described herein enable a component carrier of a cell group to have different TRP configurations from the reference cell. For example, the reference cell can be configured with an sTRP mode. A second cell of the cell group can be configured with an mTRP mode with a single DCI-based mTRP. A third cell of the cell group can be configured with an mTRP with a multiple DCI-based mTRP. The group-based TCI update can still be used for the cell group. Using the group-based TCI update reduces signal overhead between the UE and the network. The group-based TCI update reduces memory consumption overhead for the UE, as the UE does not need to store the TCI states for multiple CCs of the cell group.

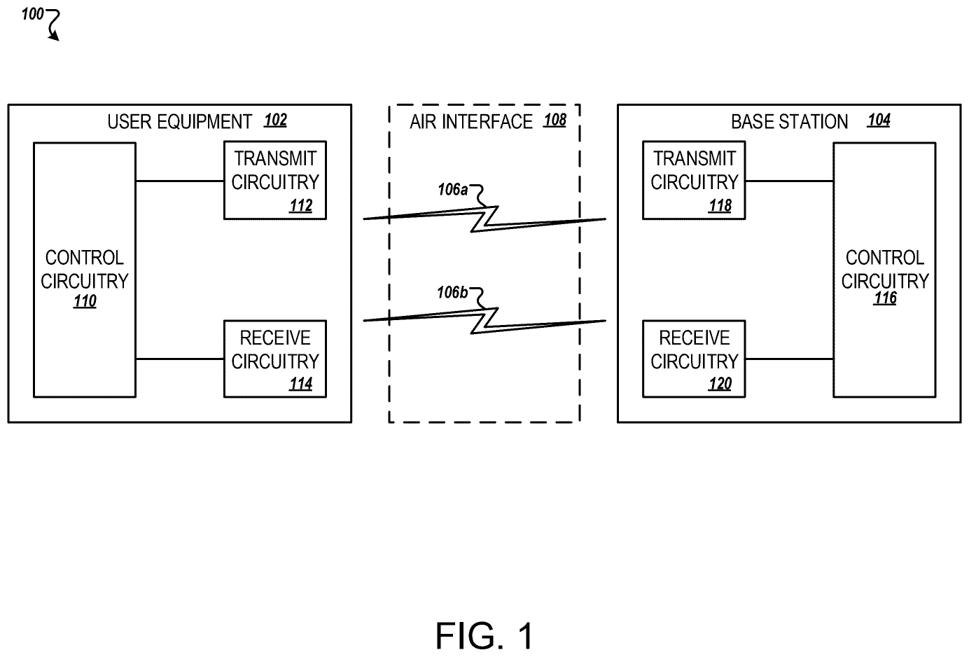

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE.

The transmit circuitry 112 can perform various operations described in this specification. The transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

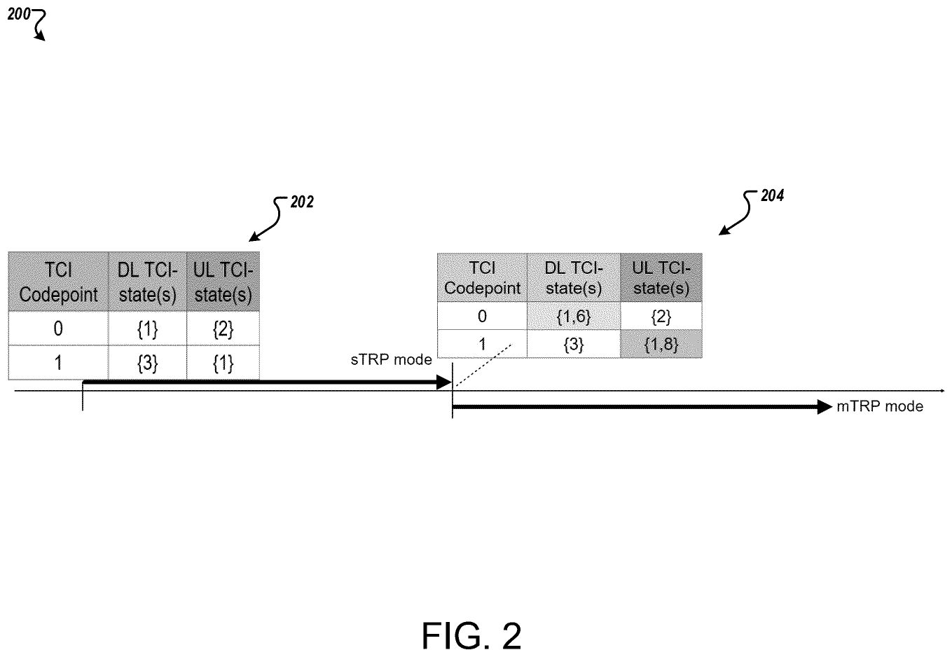

FIG. 2 illustrates an example of a network 200 configured to switch between a single TRP mode (sTRP) and a multi-TRP (mTRP) mode. Specifically, examples are described for signaling by the network for indicating to the UE, explicitly or implicitly, to switch between the sTRP and mTRP.

A DCI format 1_1 or 1_2 can include a TCI filed that indicates whether sTRP mode or mTRP mode is used for TCI-state(s). In an example, the network uses RRC to explicitly configure sDCI-based ‘sTRP’ mode or sDCI-based ‘mTRP’ mode. The RRC signaling causes the UE to update the TCI states based on the TCI field in the DCI format. In another example, switching is based on the content of Rel-18 TCI-State activation/deactivation command.

A UE determines that the ‘Rel-18 sDCI-based mTRP’ operation is used to update unified TCI-states based on several different conditions. For example, for a joint TCI mode, at least one TCI codepoint is associated with two joint TCI-states based on the activation command. A codepoint in the MAC CE is a numerical entry in the table that maps to a particular entity (e.g., a node). The UE can determine that the TCI mode for the base station (gNB) is the mTRP mode without explicit signaling from the network. The UE can configure four TCI states at the UE side. For a separate DL and UL TCI mode, at least one TCI codepoint can be associated with two DL TCI-states or two UL TCI-states. The UE can determine that the base station (gNB) is operating in the mTRP mode without explicit signaling from the network.

FIG. 2 shows data in a medium access control (MAC) control element (CE) 202. The MAC CE indicates to a UE from the base station, for each TCI codepoint value, a set of DL TCI states and a set of UL TCI states. For TCI codepoint 0, only one TCI state is designated for each of the DL TCI states and the UL TCI states. Specifically, for codepoint 0, DL TCI state is {1} and UL TCI state is {2}, and for codepoint 1 the DL TCI state is {3} and the UL TCI state is {1}. The UE can determine that the base station is operating in a sTRP mode. For MAC CE 204, more than one TCI state is indicated for either the DL TCI states or the UL TCI states for each TCI codepoint 0, 1. For example, for TCI codepoint 0, the DL TCI states are {1, 6}, which is more than one TCI state. The UE can determine that the base station is operating in the mTRP mode. Similarly, for TCI codepoint 1, the MAC CE 204 specifies multiple UL TCI states {1, 8}. The UE can determine, without explicit signaling, that the network is operating using an mTRP mode after the MAC CE 204 is received. Though both TCI codepoints 0,1 show more than one TCI state, the UE can determine that the network is operating in an mTRP mode based on either TCI codepoint 0 or 1 individually including more than one TCI state for UL or DL. In each of the examples of FIG. 2, a single MAC CE 202 or MAC CE 204 is received by the UE.

In another example, a dedicated logical cell identifier (eLCID) is a MAC subheader that indicates a Rel-18 activation/deactivation command. The UE can determine that the MAC CE 202 or MAC CE 204 represents a Rel-18 mTRP operation (rather than Rel-17 sTRP operation) if the Rel-18 activation/deactivation command is detected based on the value of the dedicated eLCID. The UE can use the eLCID to determine that the network is operating in an mTRP mode even if only one TCI state is indicated for each of the UL and DL TCI state information in the MAC CEs 202, 204.

A UE can be configured with a set of control resource sets (CORESETs). A CORESET is a set of physical resources (e.g., a specific area on a DL resource grid) and a set of parameters that is used to carry PDCCH/DCI. In this example, each CORESET is associated with one of two modes by RRC signaling. The UE updates the TCI-States according to the mode value associated with the CORESET in which the DCI is detected.

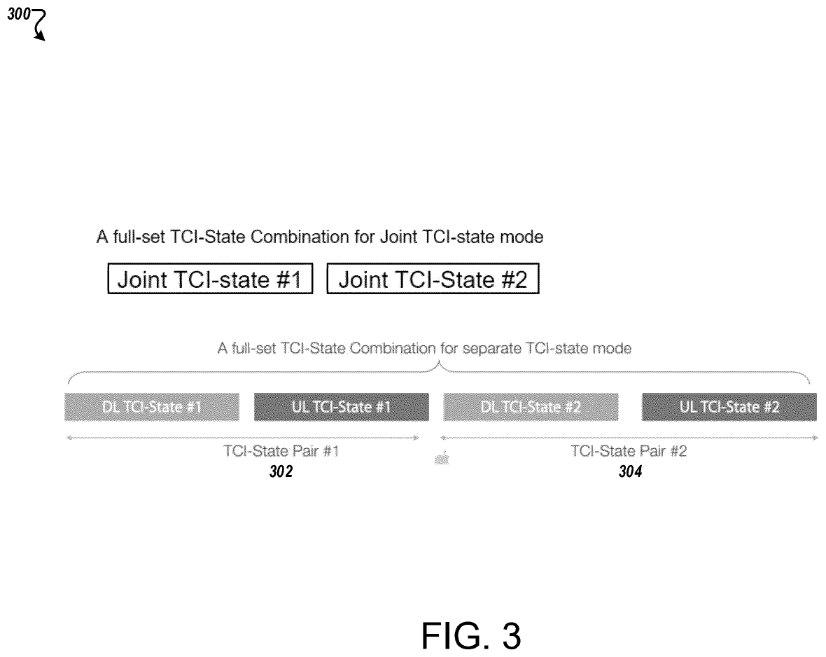

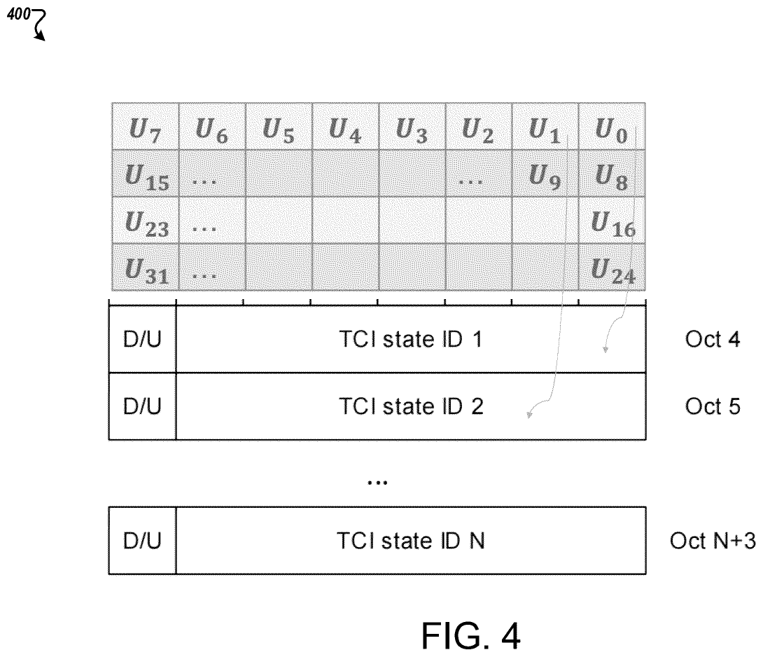

FIG. 3 shows an example of a full set (e.g., four states) of TCI-state combinations 300 for a joint TCI state mode and a separate TCI-state mode. The combination includes a first pair 302 and a second pair 304. Each pair 302, 304 of TCI states includes an UL TCI state and a DL TCI state. The full set of TCI-state combinations 300 is associated with a TCI codepoint (e.g., of MAC CE 202 or 204 of FIG. 2). A MAC-CE is configured for TCI-state activation/deactivation for sDCI-based mTRP operation, as previously described. To enable the TCI-state update description, the TCI-states associated with one TCI codepoint are labeled as in FIG. 3, covering both joint and separate TCI-state modes. The MAC CE is further described in relation to FIG. 4. For both the MAC CE and the RRC approaches, signaling specifies whether the ‘first’ pair 302 of the TCI states or the ‘second’ pair 304 of TCI states is being updated. The first pair 302 includes a first UL and a first DL TCI state. The second pair 304 includes a second UL TCI state and a second DL TCI state. The first and second indicators enable the MAC CE or RRC signaling to specify the subset (<4) of the TCI states that are being updated, as previously described. FIG. 4 illustrates an example of a medium access control (MAC) control element (CE) 400 for updating a TCI state. The MAC-CE 400 can include the following fields, as shown in FIG. 4. The field Uᵢ indicates that either the first (e.g., pair 302) or the second (e.g., pair 304) TCI-state in the unified TCI-states is updated by the indicated TCI-state ‘i+1’. The Uᵢ field is set to ‘0’ to indicate that the TCI-state ‘i’ is being used to update the first TCI-state. The Uᵢ field is set to ‘1’ to indicate that the TCI-state ‘i’ is being used to update the second TCI-state. The MAC-CE 400 is identified by a MAC subheader with a dedicated eLCID, as described in relation to FIG. 2. The UE updates the TCI-states indicated by the TCI codepoint and maintains other TCI-states that are not be updated by the TCI codepoint. Each octet includes an indicator for DL/UL communication and the TCI state identifiers, comprised of the Uᵢ fields. In the example of FIG. 4, the TCI state ID 2 is associated with U₁. If the U₁ field is set to 0, the UE determines that the “first” pair 302 of the TCI states is being updated. Depending on the U/D indicator (e.g., in octet 5), the UE can determine which of the four TCI states of full set 300 to update. In this example, once the UE operates in the mTRP mode, all TCI states will be updated as needed for operation, and a subset of TCI states can be updated or the full set can be updated by the UE.

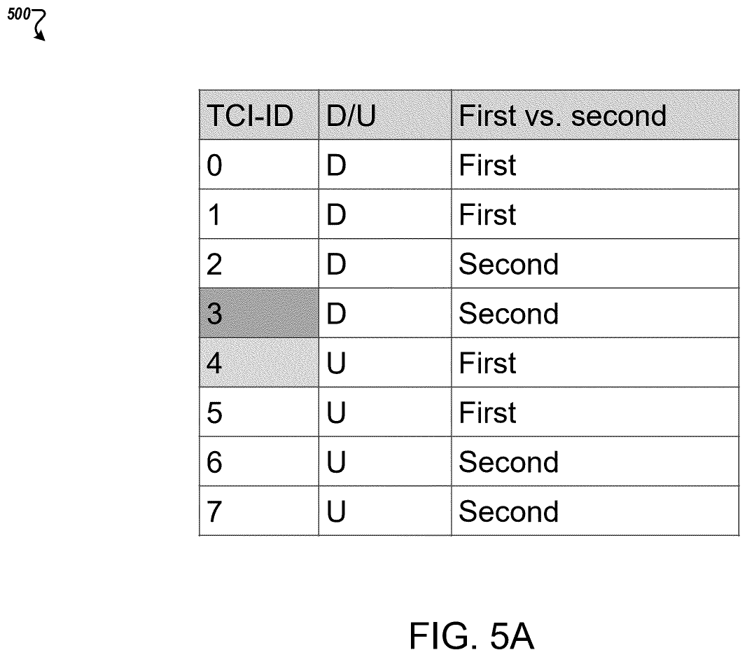

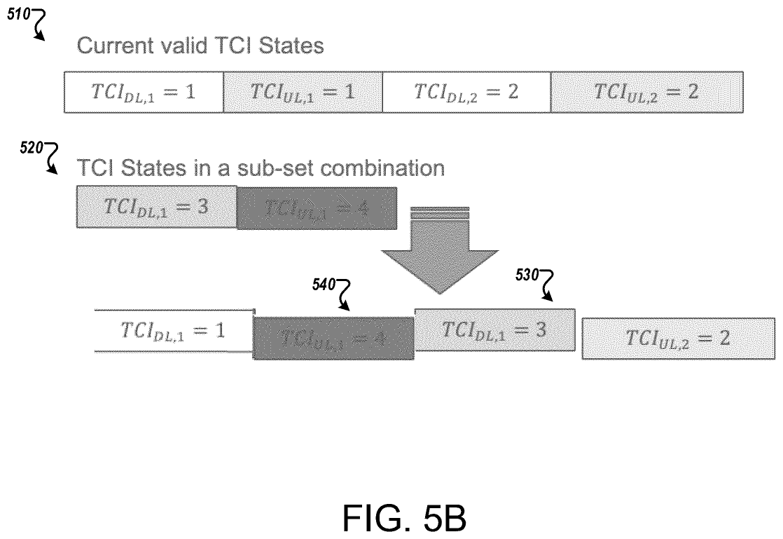

FIGS. 5A-5B show an example of a radio resource control (RRC)-based TCI-state update indication for single downlink control information (sDCI)-based multi-TRP. The network can use RRC signaling to describe the updated TCI-states to the UE. For each joint/DL/UL-TCI state, the network uses RRC signaling to indicate which TCI-state in a full-set TCI state combination (e.g., combination 300) is to be updated by it. The UE shall update the TCI-states indicated by the TCI codepoint and maintain other TCI-states that are not be updated by the TCI codepoint.

FIG. 5A shows an example TCI-state update indication information element (IE) 500 including 8 TCI-states configured by RRC signaling. The eight states include four DL TCI-states and four UL TCI-states. For each TCI-state, the RRC signaling specifies either a ‘first’ or a ‘second’ value to indicate the associated TCI-state in a full-set for update. The RRC configuration is updated with a new information element specifying the first or second state. The MAC CE 400 is transmitted more frequently than the RRC message of FIG. 5A FIG. 5B shows an example of a current full set of TCI-states 510 maintained by a UE. The current full set of TCI states 510 includes TCI states {1, 1, 2, and 2}. When the UE receives a TCI codepoint that is associated with TCI states 3/4, the UE updates the full-set 510 to be the updated set of TCI states 520. The UE updates the second DL TCI-state with TCI-state #3 and updates the first UL TCI-state in the full set 510 by TCI-state #4. The UE updates full-set of TCI-states 510 to be the updated set of TCI states 520, which include {4, 1, 3, and 2}. As shown in FIG. 5A, TCI-IDs 3 and 4 are being updated in information element 500. TCI-ID 3 is a DL in the second set. TCI-ID 4 is UL in the first set. As shown in FIG. 5B, the set of TCI-states 510 is updated to the updated set of TCI states 520. The TCI-ID in the second set for the UL (TCI sate 530) is updated with TCI-ID=3. The TCI-ID in the first set for the DL (TCI sate 540) is updated with TCI-ID=4, as specified in RRC information element 500 in FIG. 5A.

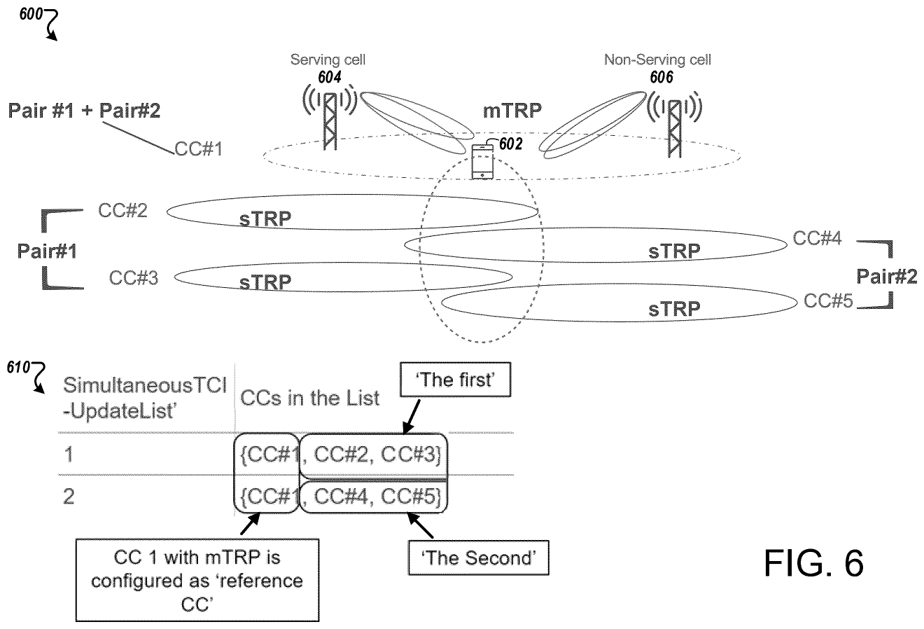

FIG. 6 illustrates an example environment 600 including a cell-group based TCI-state in which a CC list includes both sTRP-based mTRP operation and sDCI-based mTRP operation. A variety of approaches maybe considered to operate cell-group based TCI-state indication using ‘simultaneous TCI-UpdateList’ parameter. In a first example, a CC list configured by ‘simultaneous TCI-UpdateList’ includes a mix of sTRP CC(s) and sDCI-based MTRP CC(s). The UE expects that the reference CC is to be configured with an sDCI-based mTRP CC. There are two TCI states indicated by the sDCI mTRP. For each sTRP CC, RRC signaling is used to indicate that either ‘the first’ or ‘the second’ or ‘both’ of indicated TCI-states on the reference CC are used for sTRP. In another example, a CC list configured by ‘simultaneousTCI-UpdateList’ includes of a mix of sTRP CC(s) and mDCI-based MTRP CC(s). The reference CC uses mDCI mTRP. The UE expects that the reference CC is expected to be configured with an mDCI-based mTRP CC, rather than an sDCI-based mTRP CC. For each sTRP CC, RRC signaling is used to indicate that one of the following is used for sTRP. The indicated TCI-state specific to the ‘coresetPoolIndex=0’. The indicated TCI-state specific to the ‘coresetPoolIndex=1’. The indicated TCI-state specific to the ‘coresetPoolIndex=0’, and the TCI-state specific to the ‘coresetPoolIndex=1’. FIG. 6 shows an example environment 600 including a cell-group based TCI-state, where a CC list includes both sTRP and sDCI-based mTRP operation.

A CC list 610 configured by ‘simultaneous TCI-UpdateList’ includes of a mix of sDCI-based mTRP and mDCI-based MTRP CC(s). The network can support the following reference CC configurations. A first configuration (configuration #1) specifies that one of CCs with sDCI-based mTRP is indicated as reference CC. A second configuration (configuration #2) specifies that one of CCs with mDCI-based mTRP is indicated as reference CC. The network 600 is shown and the CC #1, CC #2, CC #3, CC #4, and CC #5 of the network are shown in the list 610. The UE 602 is operating in mTRP and in communication with a serving cell 604 and a non-serving cell 606. Each of the CCs #2-5 are operating in sTRP with the UE 602. CC #2 and CC #3 are the first pair, and CC #4 and CC #5 are the second pair. The TCI states for multiple cells can be updated with a single message specifying the update list in list 610. Updating multiple CCs with a single message reduces messaging overhead between the UE 602 and network 600.

Various approaches can be considered for the TCI-state indication. In a first option, a rule is hard-encoded in specification. The first TCI state of sDCI-based mTRP is mapped to the indicated TCI-state specific to the ‘coresetPoolIndex=0.’ Conversely, when the mDCI-based mTRP is the reference CC, the ‘coresetPoolIndex=0’ can update the first TCI state of the other CCs in the group. The second TCI state of sDCI-based mTRP is mapped to the indicated TCI-state specific to the ‘coresetPoolIndex=1.’ Conversely, when the mDCI-based mTRP is the reference CC, the ‘coresetPoolIndex=1’ can update the second TCI state of the other CCs in the group. In a second option, RRC signaling is used to indicate which of the two TCI-states on the reference CC is used. In case of the first configuration, the ‘first’ or ‘second’ TCI-state is configured to update the TCI-state specific to the ‘coresetPoolIndex=0’ and TCI-state specific to the ‘coresetPoolIndex=1’ on an sDCI-based mTRP CC, and vice versa (as described previously). In case of the second configuration, the TCI-state specific to the ‘coresetPoolIndex=0’ or specific to the ‘coresetPoolIndex=1’ is used to update ‘the first’ or ‘the second’ TCI-state on an mDCI-based mTRP CC, and vice versa (as described previously).

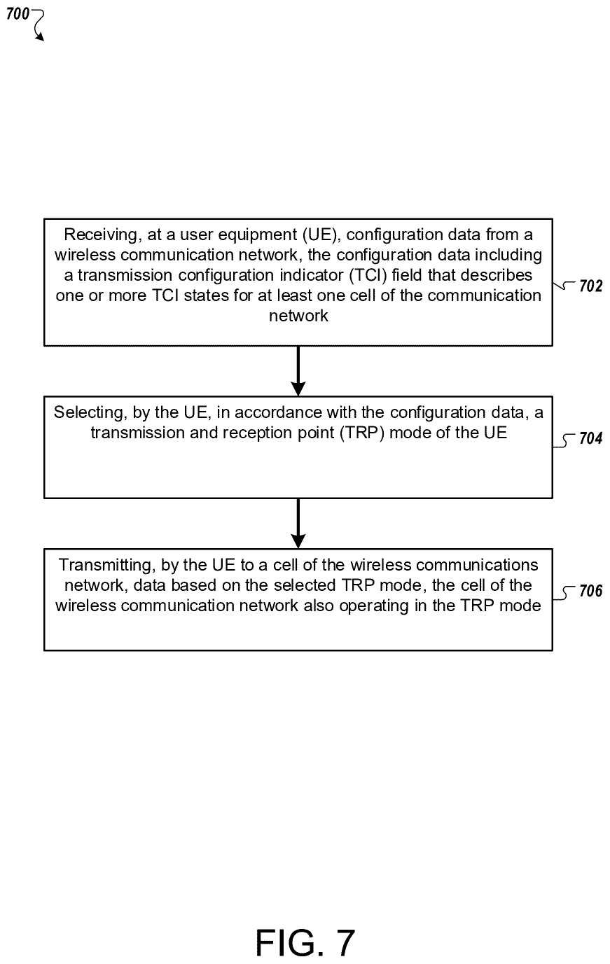

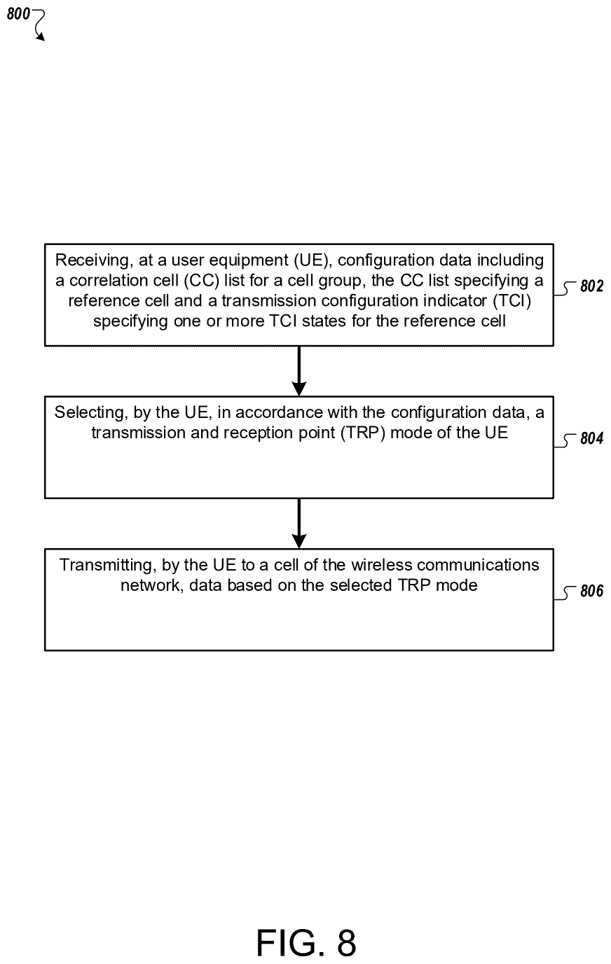

FIGS. 7 and 8 each illustrates a flowchart of an example respective method 700 and 800, according to some implementations. For clarity of presentation, the description that follows generally describes methods 700 and 800 in the context of the other figures in this description. For example, methods 700 and 800 can be performed by UE 102 of FIG. 1. It will be understood that methods 700 and 800 can be performed, for example, by any suitable system, environment, software, hardware, or a combination of systems, environments, software, and hardware, as appropriate. In some implementations, various steps of method methods 700 and 800 can be run in parallel, in combination, in loops, or in any order.

FIG. 7 shows an example process 700. Process 700 includes receiving (702), at a user equipment (UE), configuration data from a wireless communication network, the configuration data including a transmission configuration indicator (TCI) field that describes one or more TCI states for at least one cell of the communication network. Process 700 includes selecting (704), by the UE, in accordance with the configuration data, a transmission and reception point (TRP) mode of the UE, the TRP mode being a single TRP (sTRP) mode or a multi-TRP (mTRP) mode. Process 700 includes transmitting (706), by the UE to a cell of the wireless communications network, data based on the selected TRP mode, the cell of the wireless communication network also operating in the TRP mode.

In some implementations, the configuration data specifies a first number of TCI states for uplink transmissions and a second number of TCI states for downlink transmissions. In some implementations, the UE is configured to select the sTRP mode when the first number of TCI states and the second number of TCI states that are indicated in the configuration data are each an integer value that is less than two. In some implementations, the UE is configured to select the mTRP mode when the first number of TCI states or the second number of TCI states that are indicated in the configuration data include an integer value that is greater than one. In some implementations, a TCI mode is explicitly specified in a TCI field of a downlink control information (DCI) format. In some implementations, the configuration data include a logical cell identifier (eLCID), and wherein the TRP mode is based on a value of the eLCID. In some implementations, the configuration data are included in a medium access control (MAC) control element (CE), the MAC CE including a plurality of fields, wherein the plurality of fields specify a set of TCI states associated with a TCI codepoint. In some implementations, a first field value of a field of the plurality indicates a first pair of the TCI states of the full TCI state set, and wherein a second field value of the field of the plurality indicates a second pair of the TCI states of the set of TCI states. In some implementations, a MAC subheader of the MAC CE specifies an eLCID that indicates a cell associated with the set of TCI states. In some implementations, the UE is configured to update the TCI states for a cell associated with the TCI codepoint indicated in the MAC CE, and wherein the UE maintains other TCI states that are not updated in the MAC CE for the cell associated with the TCI codepoint. In some implementations, the configuration data is a part of radio resource control (RRC) signaling, and wherein the TCI field indicates TCI states for a TCI codepoint for updating by the UE. In some implementations, the RRC signaling includes a downlink/uplink identifier field and a pair identification field.

FIG. 8 shows an example process 800. Process 800 includes receiving (802), at a user equipment (UE), configuration data including a component carrier (CC) list for a cell group, the CC list specifying a reference cell and a transmission configuration indicator (TCI) specifying one or more TCI states for the reference cell, wherein the other cells in the CC list are configured to use the one or more TCI states specified for the reference cell. Process 800 includes selecting (804), by the UE, in accordance with the configuration data, a transmission and reception point (TRP) mode of the UE, the TRP mode being a single TRP (sTRP) mode or a multi-TRP (mTRP) mode. Process 800 includes transmitting (806), by the UE to a cell of the wireless communications network, data based on the selected TRP mode, the cell of the wireless communication network also operating in the TRP mode.

In some implementations, the CC list includes one or more sTRP CCs and one or more sDCI-based mTRP CCs. In some implementations, the reference cell is configured with an sDCI-based mTRP CC, and wherein radio resource control (RRC) signaling specifies that a first group, a second group, or both groups of TCI-states for the reference cell are used for sTRP.

In some implementations, the CC list includes one or more sTRP CCs and one or more mDCI-based mTRP CCs. In some implementations, the reference cell is configured with an sDCI-based mTRP CC, and wherein radio resource control (RRC) signaling specifies a value for a CORESET pool index. In some implementations, the CC list includes one or more sDCI-based mTRP CCs and one or more mDCI-based mTRP CCs. In some implementations, one of CCs with sDCI-based mTRP is indicated as reference CC. In some implementations, one of CCs with mDCI-based mTRP is indicated as reference CC. In some implementations, a first TCI state of sDCI-based mTRP is mapped to the indicated TCI-state specific to a first CORSET pool index value.

The example methods 700 and 800 shown in FIGS. 7 and 8 can be modified or reconfigured to include additional, fewer, or different steps (not shown in FIG. 7 or 8), which can be performed in the order shown or in a different order.

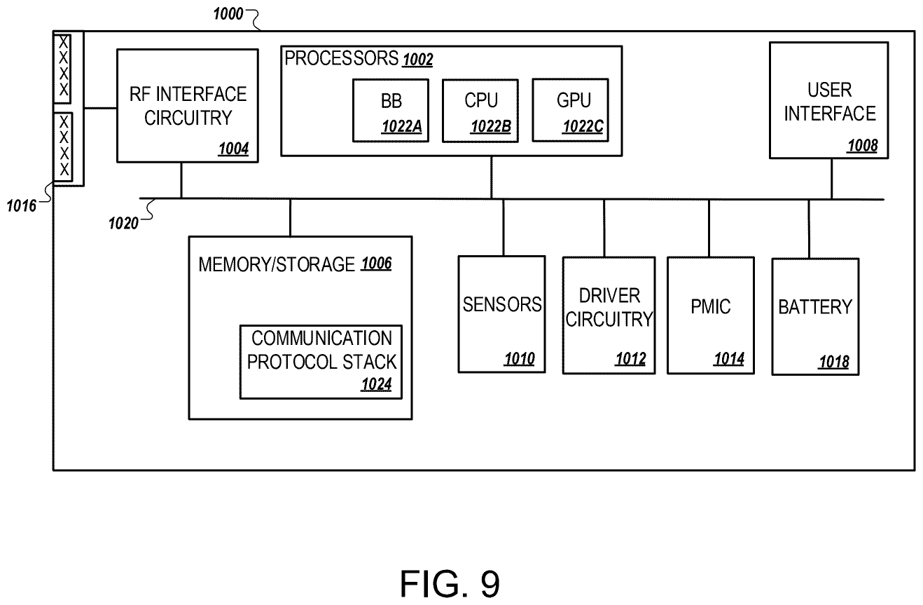

FIG. 9 illustrates an example UE 1000, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, one or more antenna(s) 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1016. In various implementations, the RF interface circuitry 1004 may be configured to transmit/receive signals in a manner compatible with NR access technologies.

The antenna(s) 1016 may include one or more antenna elements to convert electrical signals into radio waves to travel through the air and to convert received radio waves into electrical signals. The antenna elements may be arranged into one or more antenna panels. The antenna(s) 1016 may have antenna panels that are omnidirectional, directional, or a combination thereof to enable beamforming and multiple input, multiple output communications. The antenna(s) 1016 may include microstrip antennas, printed antennas fabricated on the surface of one or more printed circuit boards, patch antennas, phased array antennas, etc. The antenna(s) 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

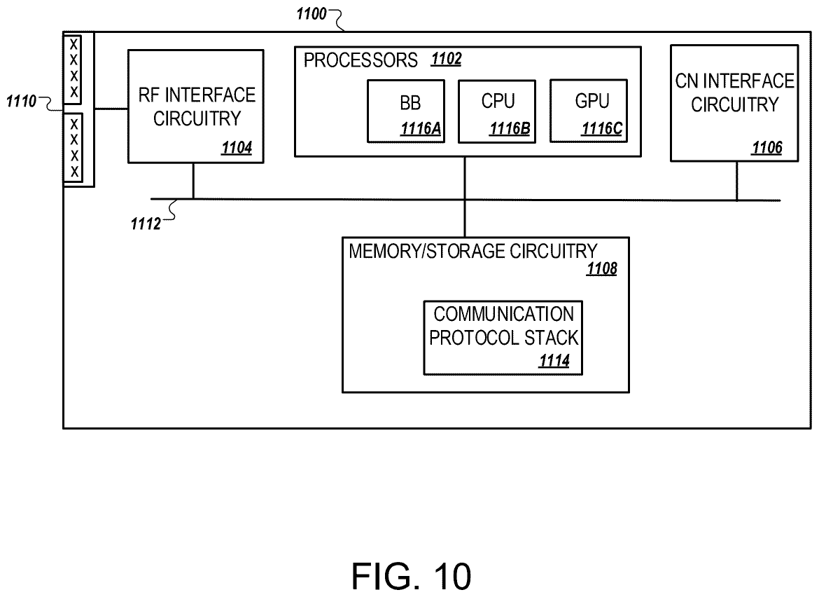

FIG. 10 illustrates an example access node 1100 (e.g., a base station or gNB), according to some implementations. The access node 1100 may be similar to and substantially interchangeable with base station 104. The access node 1100 may include processors 1102, RF interface circuitry 1104, core network (CN) interface circuitry 1106, memory/storage circuitry 1108, and one or more antenna(s) 1110.

The components of the access node 1100 may be coupled with various other components over one or more interconnects 1112. The processors 1102, RF interface circuitry 1104, memory/storage circuitry 1108 (including communication protocol stack 1114), antenna(s) 1110, and interconnects 1112 may be similar to like-named elements shown and described with respect to FIG. 9. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is

1. A method comprising:
receiving, at a user equipment (UE), configuration data from a wireless communication network, the configuration data including a transmission configuration indicator (TCI) field that describes one or more TCI states for at least one cell of the communication network; and
selecting, by the UE, in accordance with the configuration data, a transmission and reception point (TRP) mode of the UE, the TRP mode being a single TRP (sTRP) mode or a multi-TRP (mTRP) mode; and
transmitting, by the UE to a cell of the wireless communications network, data based on the selected TRP mode, the cell of the wireless communication network also operating in the TRP mode.

2. The method of claim 1, wherein the configuration data specifies a first number of TCI states for uplink transmissions and a second number of TCI states for downlink transmissions.

3. The method of claim 2, wherein the UE is configured to select the sTRP mode when the first number of TCI states and the second number of TCI states that are indicated in the configuration data are each an integer value that is less than two.

4. The method of claim 2, wherein the UE is configured to select the mTRP mode when the first number of TCI states or the second number of TCI states that are indicated in the configuration data include an integer value that is greater than one.

5. The method of claim 1, wherein a TCI mode is explicitly specified in a TCI field of a downlink control information (DCI) format.

6. The method of claim 1, wherein the configuration data include a logical cell identifier (eLCID), and wherein the TRP mode is based on a value of the eLCID.

7. The method of claim 1, wherein the configuration data are included in a medium access control (MAC) control element (CE), the MAC CE including a plurality of fields, wherein the plurality of fields specify a set of TCI states associated with a TCI codepoint.

8. The method of claim 7, wherein a first field value of a field of the plurality indicates a first pair of the TCI states of the full TCI state set, and wherein a second field value of the field of the plurality indicates a second pair of the TCI states of the set of TCI states.

9. The method of claim 7, wherein a MAC subheader of the MAC CE specifies an eLCID that indicates a cell associated with the set of TCI states.

10. The method of claim 7, wherein the UE is configured to update the TCI states for a cell associated with the TCI codepoint indicated in the MAC CE, and wherein the UE maintains other TCI states that are not updated in the MAC CE for the cell associated with the TCI codepoint.

11. The method of claim 1, wherein the configuration data is a part of radio resource control (RRC) signaling, and wherein the TCI field indicates TCI states for a TCI codepoint for updating by the UE.

12. The method of claim 11, wherein the RRC signaling includes a downlink/uplink identifier field and a pair identification field.

13. A method, comprising:
receiving, at a user equipment (UE), configuration data including a component carrier (CC) list for a cell group, the CC list specifying a reference cell and a transmission configuration indicator (TCI) specifying one or more TCI states for the reference cell, wherein the other cells in the CC list are configured to use the one or more TCI states specified for the reference cell;
selecting, by the UE, in accordance with the configuration data, a transmission and reception point (TRP) mode of the UE, the TRP mode being a single TRP (sTRP) mode or a multi-TRP (mTRP) mode; and
transmitting, by the UE to a cell of the wireless communications network, data based on the selected TRP mode, the cell of the wireless communication network also operating in the TRP mode.

14. The method of claim 13, wherein the CC list includes one or more sTRP CCs and one or more sDCI-based mTRP CCs.

15. The method of claim 14, wherein the reference cell is configured with a sDCI-based mTRP CC, and wherein radio resource control (RRC) signaling specifies that a first group, a second group, or both groups of TCI-states for the reference cell are used for sTRP.

16. The method of claim 13, wherein the CC list includes one or more sTRP CCs and one or more mDCI-based mTRP CCs.

17. The method of claim 16, wherein the reference cell is configured with a sDCI-based mTRP CC, and wherein radio resource control (RRC) signaling specifies a value for a CORESET pool index.

18. The method of claim 13, wherein the CC list includes one or more sDCI-based mTRP CCs and one or more mDCI-based mTRP CCs.

19. The method of claim 18, wherein one of CCs with sDCI-based mTRP is indicated as reference CC.

20. The method of claim 18, wherein one of CCs with mDCI-based mTRP is indicated as reference CC.

21. The method of claim 18, wherein a first TCI state of sDCI-based mTRP is mapped to the indicated TCI-state specific to a first CORSET pool index value.

22. The method of claim 21, wherein a second TCI state of sDCI-based mTRP is mapped to the indicated TCI-state specific to a second CORSET pool index value that is different from the first CORSET pool index value.

23. The method of claim 18, wherein RRC signaling specifies a TCI-state for the reference cell.

24. A system comprising one or more computers and one or more storage devices on which are stored instructions that are operable, when executed by the one or more computers, to cause the one or more computers to perform operations of any of the methods of claims 1-23.

25. A non-transitory computer storage medium encoded with instructions that, when executed by one or more computers, cause the one or more computers to perform operations of any of the methods of claims 1-23.

26. A processor of a user equipment (UE) configured to perform operations comprising:
receiving, at a user equipment (UE), configuration data from a wireless communication network, the configuration data including a transmission configuration indicator (TCI) field that describes one or more TCI states for at least one cell of the communication network; and
selecting, by the UE, in accordance with the configuration data, a transmission and reception point (TRP) mode of the UE, the TRP mode being a single TRP (sTRP) mode or a multi-TRP (mTRP) mode; and
transmitting, by the UE to a cell of the wireless communications network, data based on the selected TRP mode, the cell of the wireless communication network also operating in the TRP mode.

27. A processor of a user equipment (UE) configured to perform operations comprising:
receiving, at a user equipment (UE), configuration data including a component carrier (CC) list for a cell group, the CC list specifying a reference cell and a transmission configuration indicator (TCI) specifying one or more TCI states for the reference cell, wherein the other cells in the CC list are configured to use the one or more TCI states specified for the reference cell;
selecting, by the UE, in accordance with the configuration data, a transmission and reception point (TRP) mode of the UE, the TRP mode being a single TRP (sTRP) mode or a multi-TRP (mTRP) mode; and
transmitting, by the UE to a cell of the wireless communications network, data based on the selected TRP mode, the cell of the wireless communication network also operating in the TRP mode.
